(19) United States
(12) Patent Application Publication
(10) Pub. No.: US 2004/0171288 A1
(43) Pub. Date: Sep. 2, 2004

(54) Apparatus, articles of manufacture and method for a wire dress cover assembly

(75) Inventors: Michael Henry Banas, Kernersville, NC (US); David Allen Klein, Kernersville, NC (US)

Correspondence Address: TYCO ELECTRONICS CORPORATION, 4550 NEW LINDEN HILL ROAD, SUITE 450, WILMINGTON, DE, 19808, US

(73) Assignee: TYCO ELECTRONICS CORPORATION, MIDDLETOWN, PA

(21) Appl. No.: 10/377,199

(22) Filed: Feb. 28, 2003

(51) Int. Cl. H01R 13/44

(52) U.S. Cl. 439/135

(57) ABSTRACT

An electrical connector assembly includes an electrical connector with one or more latch receptacles, and a cover with one or more latches, in which the latch receptacles and latches are polarized so that a latch engages with a latch receptacle when the connector and the cover are aligned in a pre-determined orientation. In certain embodiments, the electrical connector has at least two latch receptacles, one of them being a first width and others being of a second, different width, and there are corresponding latches also of two different widths. In certain embodiments, the latches are in pairs, and for example, at least one pair of latches and receptacles of the same width will be on opposite sides of the cover. The pairs differ in width so that the cover is “polarized” to fit in only one orientation.

### FIELD OF THE INVENTION

The present invention relates generally to electrical connectors, and more particularly to electrical connector assemblies.

### BACKGROUND OF THE INVENTION

Electrical connectors are utilized for many purposes. Most, if not all, electrical connectors provide an electrical pathway or junction, and in so doing provide a mechanical connection between wires, circuit leads, components or other current carrying features. In addition, electrical connectors are often attached to another assembly, and with the electrical connection protected from the environment, which in some cases includes shielding from interference. Thus, there is a large category of connectors that comprise a connector base or “block” into which the electrical connections are made, and a cover or similar feature that permits assembly and subsequent access. The cover must be affixed sufficiently to remain in place while in use, but is also typically removable for subsequent access. The cover must also adequately seal out any environmental effects, and in the case of a shielding cover, provide appropriate protection from unwanted interference.

Because a connector cover is often installed and removed multiple times during assembly, and subsequently installed and removed in the field for inspection, maintenance and repair, it is important to provide a cover that has easily operable fasteners. It is additionally desirable to provide a cover for a connector that cannot be installed improperly, thereby ensuring that the functions of environmental protection and shielding are not compromised. However, many current connector and cover assembly designs are inadequate or do not carry out all these functions equally well. There exists, therefore, a need to provide an improved connector and cover assembly that improves upon the shortcomings of the prior art.

### SUMMARY OF THE INVENTION

An embodiment of an electrical connector assembly is disclosed that includes a defined number of latch receptacles and a cover with corresponding latches, and with the latch receptacles and latches preferably being polarized, so that a latch engages with a latch receptacle when the connector and the cover are aligned in a pre-determined orientation. In certain embodiments, the electrical connector has at least two latch receptacles, one of them being a first width and others being of a second, different width, and there are corresponding latches also of two different widths. In certain embodiments, the latches are in pairs, and for example, at least one pair of latches and receptacles of the width will be on opposite sides of the cover. Embodiments are further usefully applied where the cover is substantially square, and in such embodiments, pairs of latches and receptacles can be placed on opposite sides, and the pairs differ in width so that the cover is “polarized” to fit in only one orientation. In this and in similar embodiments, it may be desirable to position pairs of connectors to be symmetrical about an axis. In this and in similar embodiments, it may be desirable to position pairs of connectors to be symmetrical about an axis. In certain embodiments, it is preferred that the connector assembly be molded from a thermoplastic material, and most preferably a fiber composite material, although other suitable materials may also be utilized as well where desired. In an embodiment illustrated herein, nylon filled with glass fibers is utilized.

In another exemplary embodiment, an electrical connector assembly is disclosed that has an electrical connector block and a cover along with a plurality of latches and a plurality of latch receptacles. The latch receptacles and latches are polarized so that a latch engages with a latch receptacle when the connector block and the cover are aligned in a pre-determined orientation.

In certain embodiments, the electrical connector assembly may be held together by latches that are flexible members having an engaging section disposed on a distal end, and with the latch receptacles including a feature for connection on either side of center with the engaging section after the latch is displaced from a first position to a second position.

Methods of assembling a cover to a connector are also disclosed. In one embodiment, the cover is oriented in the correct polarity by positioning first and second latches of different widths in correspondence with first and second latch receptacles, and then pressing the cover into an assembled position, so that the latches deflect and then engage corresponding ones of the latch receptacles.

### BRIEF DESCRIPTION OF THE DRAWINGS

FIG. 1 is a front perspective view of a connector and cover assembly in accordance with an embodiment of the present invention;

FIG. 2 is a rear perspective view of the assembly shown in FIG. 1;

FIG. 3 is a front perspective view of a cover shown in FIG. 1;

FIG. 4 is a top plan view of the cover shown in FIG. 3;

FIG. 5 is a rear elevational view of the cover shown in FIG. 4; and

FIG. 6 is a left side elevation view, partially in cross-section, of the cover shown in FIG. 4.

### DETAILED DESCRIPTION

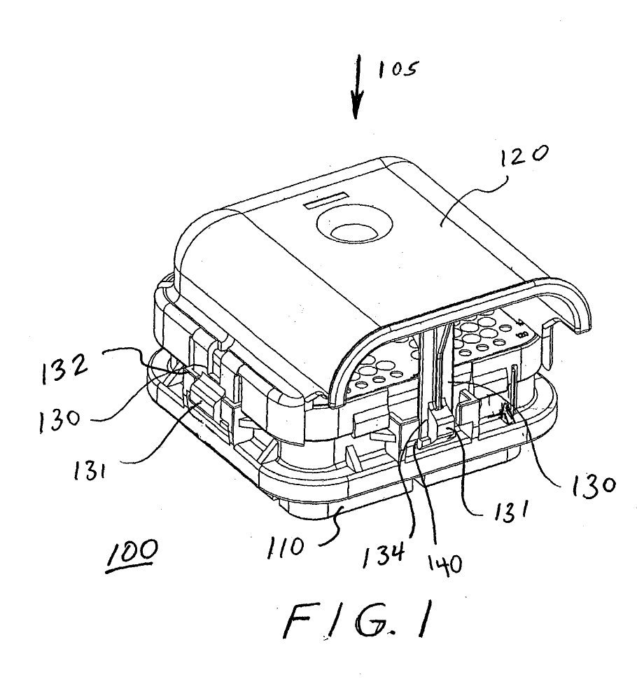

Referring now to the drawings in detail, wherein like reference numerals indicate like elements throughout the several views, there is illustrated in FIG. 1 a front perspective view of a connector assembly 100 in accordance with an embodiment of the present invention. In this embodiment, the connector assembly 100 comprises a connector 110 and a cover 120. In the exemplary embodiment illustrated in FIG. 1, the connector 100 is preferably a wire dress block adapted for providing an interconnection point for electrical wires. The cover 120 in this embodiment is generally elongated and preferably a shell, and does not include any mechanical or electrical connection features. In other embodiments, the connector 110 and/or the cover 120 may carry electrical components and/or provide electrical connections where desired. The present embodiment also preferably includes one or more latches 130, which are disposed along the sides of the assembly 100 in the embodiment illustrated in FIG. 1. In the present embodiment, the latches are generally rectangular in configuration and attached at one end to the cover 120. It should be noted that in certain embodiments, the latch 130 will have different widths embodiment, wherein the latches are generally rectangular, the parallel sides of the generally rectangular configuration of the latches will have narrower latches then the one parallel sides of the generally rectangular configuration of the latches. In the exemplary embodiment of FIG. 1, a plurality of latches 130 are provided, and at least one, and preferably each of the latches 130 corresponds to and is in registration with a latch receptacle 140, which is generally rectangular in this embodiment. For assembly of the connector 110 and cover 120 in this embodiment, the cover 120 is preferably moved downwardly in the direction of arrow 105, so that the resilient latches 130 contact against the connector 110 deflecting inwardly, and then back toward their original position to engage in the corresponding latch receptacles 140, locking the two components together when the cover 120 is in its final, closed position. As shown in FIG. 1, the latches 130 preferably include an engagement feature 131 disposed on their distal ends that engage latch receptacles 140 on both sides of center. In the present embodiment, the engagement feature 131 comprises a generally elongate boss extending from an outer surface of latches 130 primarily intended for ease of disengagement of the latches when depressed between the engaging surfaces of the receptacle features. Although it should be understood that any suitable design may be used for such engagement feature and corresponding latch receptacle, as are well known to those of ordinary skill in the art. In the present embodiment, preferably the latch structures exhibit low stress so as to reduce fatigue failure, while permitting high deflection to provide adequate latching functionality. Further, it is preferred in this embodiment that latches 130 are resilient enough to be easily engaged and disengaged, yet strong enough to preclude inadvertent or unintended release. In alternate embodiments beyond that shown in FIG. 1, the latch and receptacle structures may be interchanged. In other words, in certain embodiments, the latch(es) will extend from the connector and the cover will include the latch receptacle(s) or an equivalent feature. As will be described in more detail below, four latches 130 are illustrated in the present embodiment, defined by a pair of latches 132, a latch 133 and a latch 134.

Referring now to FIG. 2, there is illustrated a rear perspective view of the connector assembly 100 shown in FIG. 1. In this view, one of the pair of latches 132 is shown, which is located at the far right. This same latch 132 is also shown in FIG. 1 but viewed from a different perspective, which is located at the far left. In the illustrated embodiment, as explained in detail below, a pair of corresponding latches 132 are provided disposed on directly opposite sides on cover 120. Also shown in FIG. 2, latch 133 is provided, which is located directly opposite the latch 134 shown in FIG. 1.

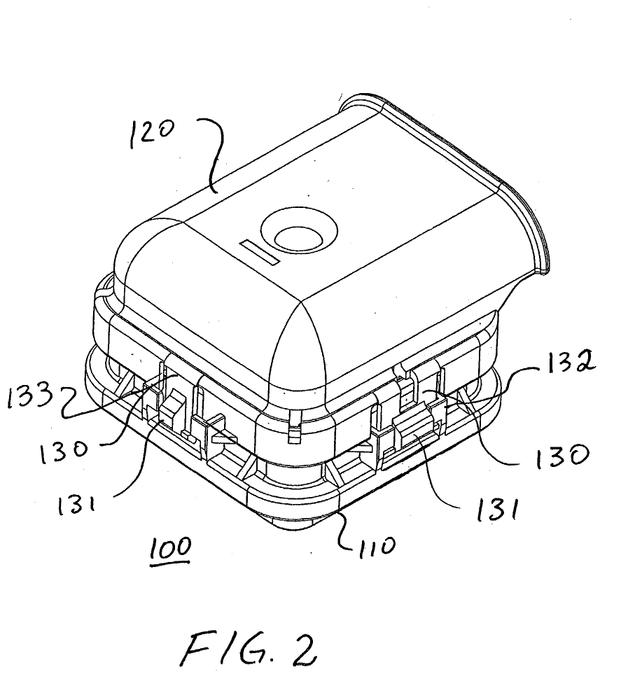

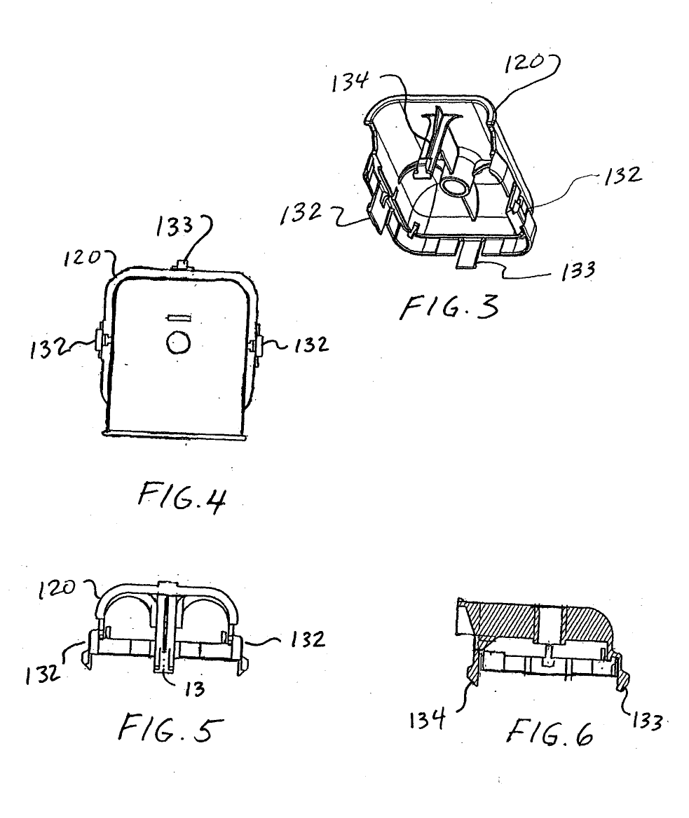

As illustrated in FIG. 3, the placement of the various latches 130 is shown by a perspective view of the cover 120 from the “underside” or interior of the assembly. The pair of latches 132 disposed opposite one another are identical in this embodiment, and the other two latches 133, 134 are arranged opposite one another but differ in design due to the differences in the cover 120 at the location where each latch 133, 134 is located. In accordance with one aspect of the present embodiment, it is preferred that the width of the first pair of latches 132 differ from the width of the other latches 133, 134. By making each pair of opposing latches with a different width, the cover 120 is “polarized” with respect to the connector 110, in that there is one and only one way to affix the two portions together, so that latches 130 will properly engage the receptacles 140 and not be damaged or mis-aligned.

The differential latch width described above, as well as further features of an exemplary embodiment of the invention are seen in FIGS. 4-6. In FIG. 4, a top plan view of the cover 120 is shown and the opposite pair of latches 132 of a first width is seen, along with the latch 133 of a different width. Turning to FIG. 5, a rear elevational view shown illustrates the fourth latch 134 that is aligned with, opposite and the same width as the latch 133, which is a different width that that of the latches 132 disposed along adjacent sides. Finally, a left side elevational view is illustrated in FIG. 6, which is in cross-section, showing the manner by which latches 133,134 are aligned opposite one another, and although different in length, extend to the same latch depth and have similar sized elements.

In addition to the general mechanical design considerations described above by which the design disclosed herein provides a low stress, high deflection latch, the device preferably also has high strength, which is primarily a function of material selection. A preferred material for use in the illustrated embodiment is nylon or Poly(p-phenylene sulfide) (PPS). PPS is a highly stable polymer in terms of both thermal degradation and chemical reactivity. PPS is a semi-crystalline polymer with a high crystalline melting point of about 285° C. (545° F.). Because of its molecular structure, PPS also tends to char during combustion, making the material inherently flame retardant. PPS does not dissolve in any solvent at temperatures below about 200° C. (392° F.). When blended with glass fibers and other fillers, PPS has both long-term and short-term thermal stability, high modulus and creep resistance, high resistance to aggressive chemical environments, permits precision molding to tight tolerances with high reproducibility, has inherent non-flammability, and good insulating properties over a wide range of conditions PPS is available commercially under the trade name Ryton™ from the Chevron Phillips Chemical Company LP, P.O. Box 4910, The Woodlands, Tex. 77387-4910. Glass-filled PPS is also sold commercially by Ensinger GmbH, Rudolf-Diesel Str. 8, 71154 Nufringen, Germany under the trade name “Tecatron.” A product called “Tecatron GF 40” contains 40% glass fibers and is a preferred material for use with the invention. As should be understood, however, any other suitable materials may also be utilized where desired for these same purposes.

The embodiments disclosed herein also presents improved methods for assembling a connector and cover by providing at least two latch structures of different widths arranged, so that the cover is “polarized” and can be placed on the connector in only one orientation. In particular, in certain embodiments, two pairs of latches disposed on opposite sides of a substantially square housing are provided. In this particular embodiment, possible confusion or improper installation of the cover is precluded due to the polarized latch arrangement. In such embodiments, placing the latches in a symmetrical manner and using only the width of the latches as the polarization “key” aid manufacturing the components and tolerance control.

Upon review of the foregoing, numerous adaptations, modifications, and alterations will occur to the reviewer. These will all be, however, within the spirit of the invention. For example, in other embodiments, latches 132 and/or latches 133, 134 can be positioned so that they are not located directly opposite each other. In other words, located at any position on cover 120 and/or connector 110. In addition, the polarization feature may be based on characteristics other than width of the latches 130/receptacles 140, such as, for example, shape, depth, etc. In addition, while in the illustrated embodiment, each of the latches 130/receptacles 140 serves as a polarization feature, this may be varied in other embodiments to include fewer than all, in particular, any desired number of latches 130/receptacles 140. Accordingly, reference should be made to the appended claims in order to ascertain the true scope of the present invention.

We claim:

1. An electrical connector assembly comprising:
an electrical connector block;
cover;
one or more latch receptacles attached with at least one of said electrical connector block or cover; and
one or more latches attached with at least one of said cover or electrical connector block and adapted to engage said one or more latch receptacles;
wherein at least one of the one or more latch receptacles and one or more latches are polarized so that the one or more latches engage with the one or more latch receptacles when the electrical connector block and the cover are aligned in a pre-determined orientation.

2. The connector of claim 1, wherein the one or more latch receptacles comprises first and second latch receptacles, the first latch receptacle being of a first width and the second latch receptacle being of a second, different width; and the one or more latches comprises first and second latches, the first latch having a latching portion corresponding to the first width and the second latch having a latching portion corresponding to the second, different width, whereby the first and second latches engage the corresponding first and second latch receptacles in a mounted position of the cover.

3. The connector of claim 1, wherein the one or more latch receptacles comprises first, second, third and fourth latch receptacles, the first and second latch receptacles being of a first width and the third and fourth latch receptacles being of a second, different width; and the one or more latches comprises first, second, third and fourth latches, the first and second latches having a latching portion corresponding to the first width and the third and fourth latches having a latching portion corresponding to the second, different width, whereby the first, second, third and fourth latches engage the corresponding first, second, third and fourth latch receptacles in a mounted position of the cover.

4. The connector of claim 2, wherein the first and second latch receptacles and the first and second latches are located on the electrical connector block and cover.

5. The connector of claim 4, wherein the first and second latch receptacles and the first and second latches are each located opposite one another on the electrical connector block and cover.

6. The connector of claim 3, wherein the first and second latch receptacles and the first and second latches are each located opposite one another on the electrical connector block or cover, and the third and fourth latch receptacles and the third and fourth latches are each located opposite one another on the electrical connector block or cover.

7. The connector of claim 6, wherein the cover is generally elongated, with each of said first and second latches located on said cover proximate opposite sides of said cover, and each of said third and fourth latches located on said cover proximate opposing ends of said cover.

8. The connector of claim 1, wherein and said latches define generally elongate members attached at one end to said cover or said electrical connector block and said latches further include an engagement feature proximate a distal end.

9. The connector of claim 8, wherein said cover comprises a thermoplastic material formed into a fiber composite material.

10. The connector of claim 8, wherein the thermoplastic material is nylon.

11. An electrical connector assembly, comprising:
an electrical connector block and a cover, the assembly further comprising a plurality of latches and a plurality of latch receptacles, wherein the latch receptacles and latches are polarized so that a latch engages with a latch receptacle when the connector block and the cover are aligned in a pre-determined orientation.

12. The connector of claim 11, wherein the assembly comprises at least two latch receptacles, one of the receptacles being of a first width and one or more receptacles being of a second, different width; and at least two latches, one of the latches being of a first width and one or more latches being of a second, different width, and wherein the latches and receptacles of a first width are not symmetric with the latches and receptacles of a second width.

13. The connector of claim 12, wherein the assembly comprises at least four latch receptacles, two of the receptacles being of a first width and disposed on opposite sides of the assembly and two or more receptacles being of a second, different width; and at least four latches, two of the latches being of a first width and disposed on opposite sides of the assembly, and two or more latches being of a second, different width.

14. The connector of claim 11, wherein the assembly is substantially square in shape, and a first pair of latches of a first width are disposed on a first pair of opposite sides, and a second pair of latches of a second width are disposed on a second pair of opposite sides.

15. The connector of claim 11, wherein the cover is molded from a thermoplastic material.

16. The connector of claim 15, wherein the thermoplastic material is formed into a fiber composite material.

17. The connector of claim 16, wherein the thermoplastic material is nylon.

18. The assembly of claim 11, wherein the latches are flexible members having an engaging section disposed on a distal end, and the latch receptacles include a feature for engaging the engaging section after the latch is displaced from a first position to a second position.

19. The assembly of claim 12, wherein at least one of two latches of the same width are of different length.

20. A method of assembling a cover to a connector comprising the steps of:
(a) orienting the cover in the correct polarity by:
positioning a first latch in correspondence with a first latch receptacle, wherein said first latch and latch receptacle have a first width; and
positioning a second latch in correspondence with a second latch receptacle, wherein said second latch and latch receptacle have a second width; and
(b) pressing the cover into an assembled position,
whereby the first and second latches first deflect and then engage corresponding ones of the first and second latch receptacles.
